(19) United States
(12) Patent Application Publication
(10) Pub. No.: US 2025/0245065 A1
(43) Pub. Date: Jul. 31, 2025

(54) LOAD BALANCING TECHNOLOGIES

(71) Applicant: Intel Corporation, Santa Clara, CA (US)

(72) Inventors: Giovanni CABIDDU, Shannon (IE); Laurent COQUEREL, Limerick (IE); Fiona TRAHE, Ennis (IE); Fei Z. WANG, Shannon (IE)

(21) Appl. No.: 19/179,490

(22) Filed: Apr. 15, 2025

(51) Int. Cl. G06F 9/50

(52) U.S. Cl. CPC G06F 9/505

(57) ABSTRACT

Examples described herein relate to circuitry to access a request to perform operations written to a single queue. In some examples, the circuitry is to allocate the operations from the single queue to multiple queues associated with multiple accelerators based on load data of the multiple accelerators. In some examples, at least one of the multiple accelerators is associated with at least two queues.

### DESCRIPTION

Data centers provide processing, storage, and networking resources for customers. For example, automobiles, smart phones, laptops, tablet computers, or internet of things (IoT) devices can leverage data centers to perform data analysis, data storage, or data retrieval. Data centers include processors and devices such as memory, accelerators, network interface devices, and others. Processes utilize accelerators to offload operations from processors and to potentially speed up completion of processes and reduce power usage.

### BRIEF DESCRIPTION OF THE DRAWINGS

FIGS. 1-3 depict prior art systems.

FIG. 4 depicts an example system.

FIG. 5 depicts an example of operations.

FIG. 6 depicts an example process.

FIG. 7 depicts an example computing system.

### DETAILED DESCRIPTION

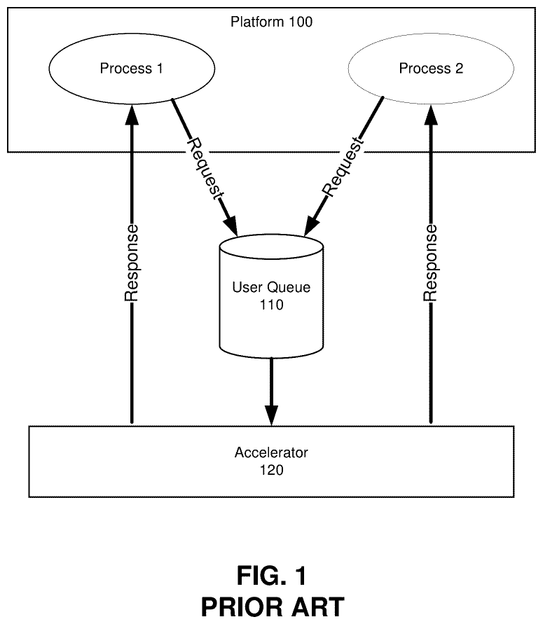

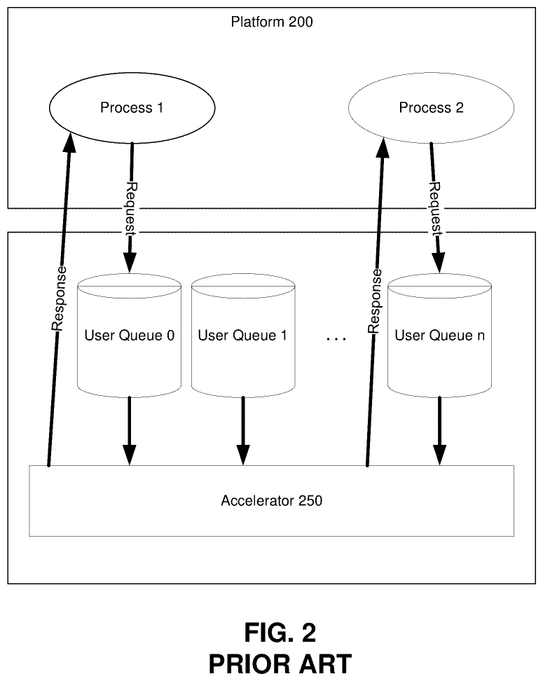

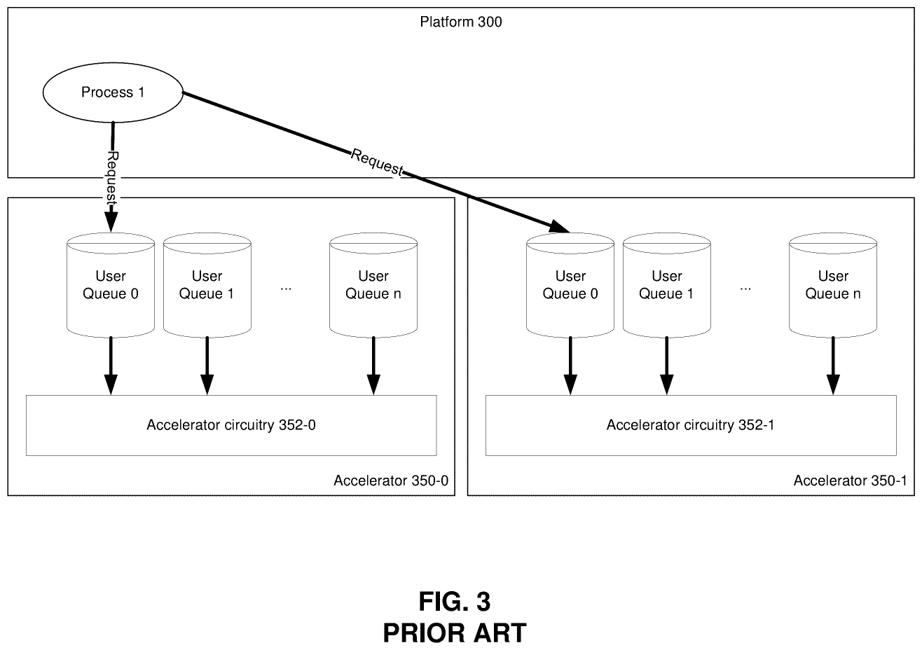

FIG. 1 depicts a prior art system whereby processor-executed processes 1 and 2 of platform 100 submit requests to user queue 110 for a single accelerator device 120. Accelerator device 120 can perform the requests in a first in first out manner. FIG. 2 depicts another prior art system. Processor-executed user processes 1 and 2 of platform 200 submit requests to accelerator device 250 via multiple user queues 0 to n, where n is an integer, for execution. Accelerator device 250 performs load balances requests from different user queues 0 to n. FIG. 3 depicts a prior art system in which processor-executed process 1 discovers accelerators 350-0 and 350-1, which perform the same offloaded operations, and requests a kernel driver to access queues associated with accelerators 350-0 and 350-1. Accelerator 350-0 exposes one or more of multiple user queues 0 to n in memory in user space to process 1. Similarly, accelerator 350-1 exposes multiple user queues 0 to n in memory in user space to process 1. In the systems of FIGS. 1-3, processes submit requests to queues of accelerators to a single queue or multiple queues in a round robin manner, irrespective of load of the queues. In turn, accelerators perform operations from in a first in first out manner.

At least to load balance operations, from a process, among multiple accelerator devices that could perform the operations, various examples can provide the process with access to a single queue of a dispatcher circuitry and the dispatcher circuitry can load balance the operations, submitted to the queue, among the multiple accelerator devices. The dispatcher circuitry can select an accelerator to perform the operations based on telemetry metrics and/or priority of the operations. In some examples, the process can access a dispatcher circuitry as a Peripheral Component Interconnect express (PCIe) device. Capability of the dispatcher circuitry to load balance requests submitted to a single queue can be reported through PCIe configuration space in memory, a memory region, or registers. User space processes can submit requests to perform operations to the queue associated with the dispatcher circuitry and the dispatcher circuitry can load balance the operations among the multiple accelerator devices in a platform or an accelerator remote to the platform and accessible via Ethernet packets transmitted and received by a network interface device.

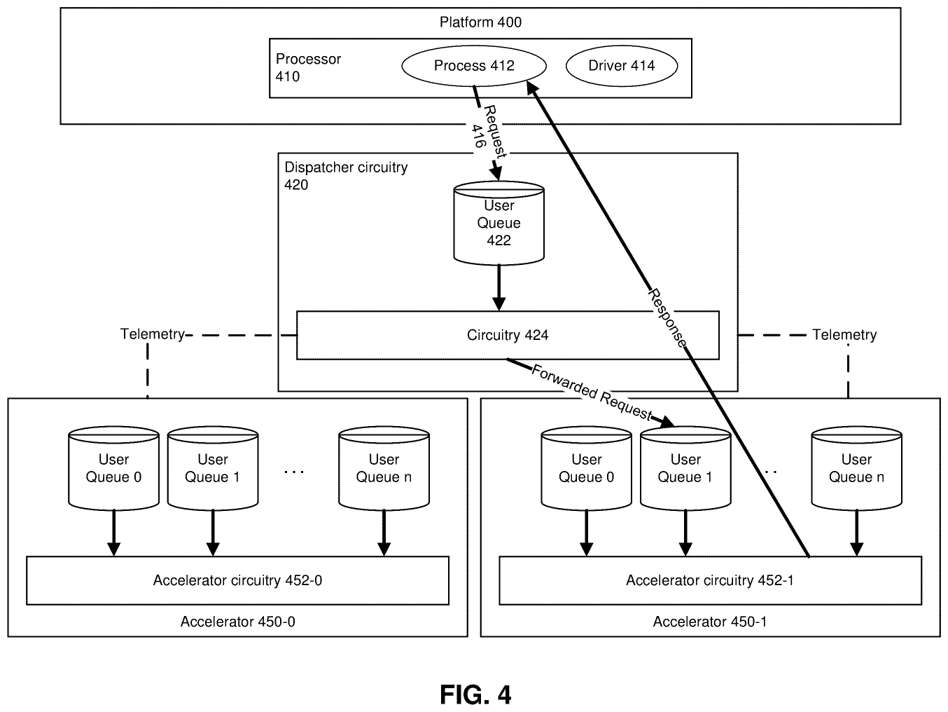

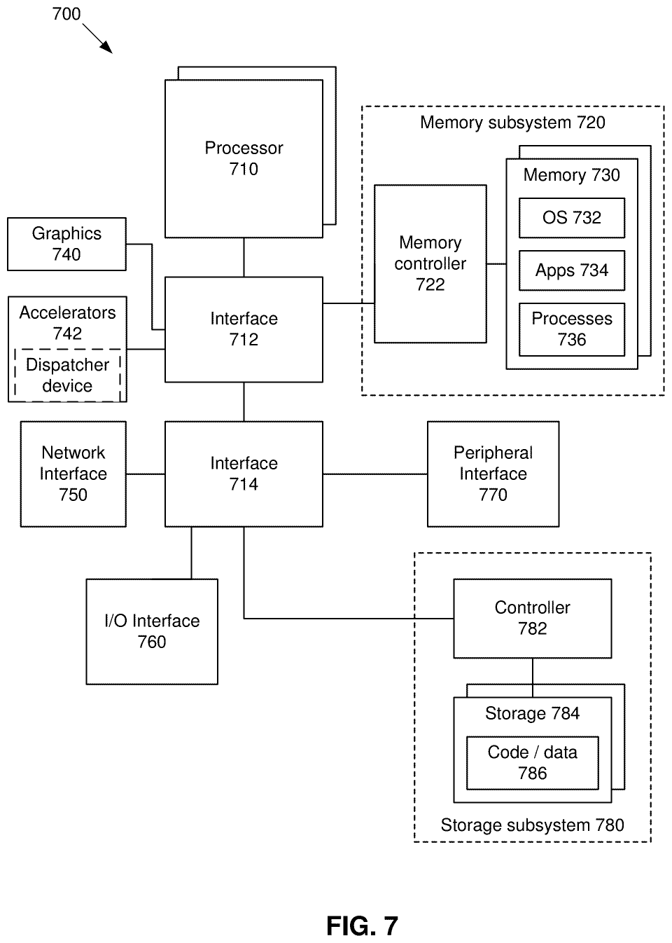

FIG. 4 depicts an example system. Platform 400 can include at least processor 410, and circuitry and software described at least with respect to FIG. 7. For example, processor 410 can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A processor core can access to its own cache and read only memory (ROM), or multiple cores can share a cache or ROM. Processor cores can be homogeneous (e.g., same processing capabilities) and/or heterogeneous devices (e.g., different processing capabilities). A core can be sold or designed by Intel®, Advanced RISC Machines (ARM)®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processor 410 can execute process 412. Process 412 can include one or more of: an application, process, thread, a virtual machine (VM), microVM, container, microservice, virtual function (VF), virtual device, or other virtualized execution environment. As described herein, process 412 can submit requests 416 to user queue 422 associated with dispatcher circuitry 420. For example, at least one of requests 416 can specify at least: a starting memory address of data to be processed, a starting memory address of a result, operation to perform, quality of service (QoS), priority level, or other parameters. User queue 422 can be allocated in memory or one or more registers.

Dispatcher circuitry 420 can load balance requests 416 in user queue 422 among one or more of accelerator circuitries 450-0 to 450-A, where A is an integer and can be 1 or more. In some examples, accelerator circuitries 450-0 to 450-A are capable of performing requests 416. For example, process 412 can request dispatcher circuitry 420 to perform operations of a request 416 by accessing dispatcher circuitry 420 as a single PCIe device accelerator. Dispatcher circuitry 420 can load balance operations received from process 412 among accelerator circuitry 450-0 to 450-A based on a policy that considers telemetry data and/or priority of the requests. Although two accelerator circuitries are shown, more than two accelerator circuitries can be accessed by dispatcher circuitry 420. In addition, although a single process 412 is shown, processor 410 can execute multiple processes that can submit requests to user queue 422 for dispatcher circuitry 420 to load balance among accelerator circuitries 450-0 to 450-A.

Accelerator circuitries 450-0 to 450-A can perform one or more of: encryption, decryption, compression, decompression, packet transmission, packet receipt, data copying, cyclic redundancy check (CRC) calculations, matrix multiplication, convolution, tensor operations, arithmetic, inference, or others. Accelerator circuitries 450-0 to 450-A can include a network interface device, application-specific integrated circuit (ASIC), Field Programmable Gate Array (FPGA), neural processing units (NPUs), graphics processing units (GPUs), tensor processing units (TPUs), or others. Examples of accelerator circuitries 450-0 to 450-A can include Intel® QuickAssist (QAT), Intel® In-Memory Analytics (IAA) Intel® Data Streaming (DSA), or others.

An initialization phase of dispatcher circuitry 420 can be as follows. At (1), processor-executed dispatcher device driver registers acceleration devices 450-0 to 450-1 to dispatcher circuitry 420. At (2), a system administrator can configure a load balancing policy for dispatcher circuitry 420 to distribute requests across acceleration devices 450-0 to 450-1 or provide requests to merely a single accelerator device or a strict subset of acceleration devices 450-0 to 450-1.

In some examples, process 412 can request performance of a job of operations to dispatcher circuitry 420 by: preparing a descriptor in memory for the job to be offloaded, opening dispatching circuitry 420, writing request 416 to registers or region of memory in user space in a User Queue (UQ) 422 window, and submitting the descriptor to registers or region of memory allocated to dispatch device 420 using an instruction that allow user space processes to submit jobs to accelerators directly from user space without interacting with the kernel and allow multiple processes to concurrently target the same queue. In some examples, the instruction can include Intel® x86 ENQCMD or ENQCMDS CPU instructions. The ENQCMD instruction allows process 412 to write commands to enqueue registers, which are device registers accessed using memory-mapped I/O (MMIO). ENQCMDS is a variation of ENQCMD used in kernel space.

Device driver 414 can expose User Queue (UQ) 422 to user space process 412. In some examples, request 416 can be written to dispatcher circuitry 420 as an MMIO and device driver 414 can interpret and process commands submitted to MMIO regions or registers associated with dispatcher circuitry 420. To allow the direct enqueueing of commands, MMIO region can include a User Queue (UQ) 422 window or portal. User space processes 412 can write commands to the UQ window for dispatch to an accelerator selected by dispatcher circuitry 420. The UQ window can be mapped to address space of a user space process and execution of the ENQCMD instruction can enqueue descriptors to the UQ window. Device driver 414 can provide dispatcher device 420 with access to accelerator devices 450-0 to 450-A.

In some examples, request 416 can be implemented as an application programming interface (API) to dispatcher circuitry 450 to cause processing of a request 416 in UQ 422.

For example, circuitry 424 of dispatcher circuitry 420 can apply a load balancing policy to select one or more accelerators 452-0 to 452-A to perform operations from process 412 based on telemetry data and/or priority of process 412 or priority of the request to perform operations from process 412. Example load balancing policies can include: select least loaded accelerator, select accelerator physically closest to processor that executes a process that requested performance of operations (e.g., lowest latency to transmit and receive data), select accelerator with highest bandwidth interface to accelerator, select accelerator that is physically closest to the memory that stores the data to be processed, round robin, select a single accelerator to perform operations, or others. For example, the policy can be configured by a data center administrator. Telemetry data can include one or more of: a queue depth of an accelerator, a number of operations to be performed by a particular accelerator of multiple accelerators, an average amount of time to completion by a particular accelerator of multiple accelerators, or others. Dispatcher circuitry 420 can be positioned in a package of a processor, integrated into an accelerator circuitry, integrated into an accelerator circuitry, or accessible as a PCle or Compute Express Link (CXL) device. Dispatcher circuitry 420 can be implemented as a process executed by processor 410.

For example, based on a high level priority of process 412 or the request having a high level of priority, dispatcher circuitry 420 can select a least loaded accelerator, accelerator with lowest latency to transmit and receive data, and/or highest bandwidth interface to the accelerator. For example, based on a low level priority of process 412 or the request having a low level of priority, dispatcher circuitry 420 can select a more loaded accelerator, accelerator with higher latency to transmit and receive data, and/or lower bandwidth interface to the accelerator.

Based on selection of an accelerator of accelerators 452-0 to 452-A to perform a request in user queue 422, circuitry 424 of dispatcher circuitry 420 can provide the request to a queue associated with the selected accelerator.

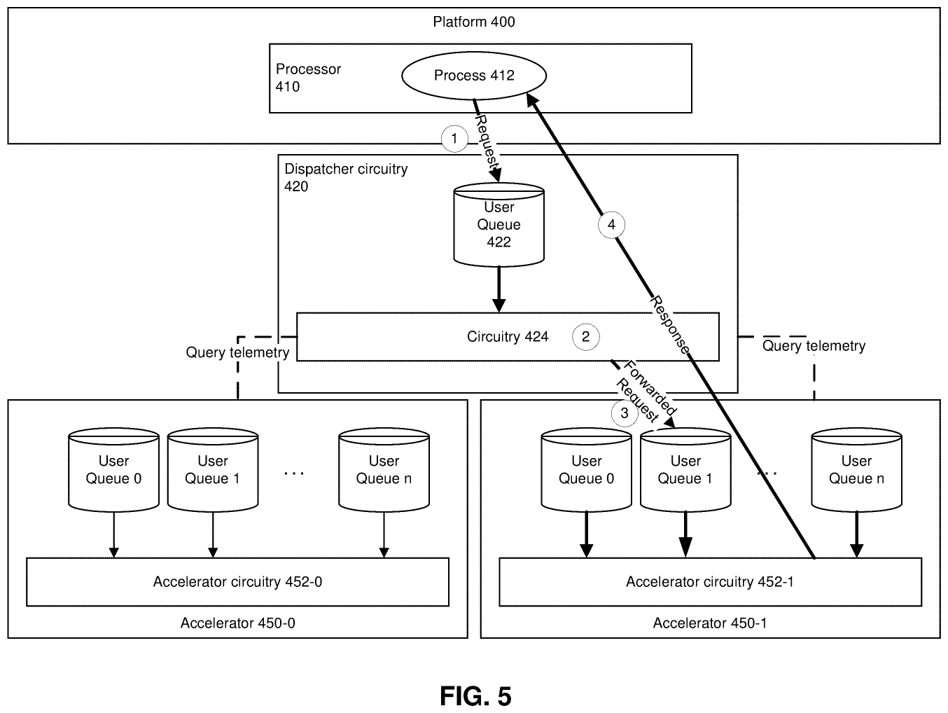

FIG. 5 depicts an example of operations. At (1), a user space process 412 accesses dispatching circuitry 420 by calling a file or device name, maps registers or region of memory in user space to the User Queue (UQ) 422 window, prepares a descriptor in memory for the job to be offloaded, and submits the job descriptor to dispatching circuitry 420 by targeting register or address space associated with dispatching circuitry 420. At (2), dispatching circuitry 420 selects an accelerator and accelerator queue based on telemetry data of the accelerators and the applicable policy. At (3), dispatching circuitry 420 forwards the request to a queue (e.g., user queue 1) of the selected accelerator (e.g., accelerator circuitry 452-1). Accelerator circuitry 452-1 performs computation associated with the job for the forwarded request. At (4), based on completion of the computation, the accelerator (e.g., accelerator circuitry 452-1) sends a response to process 412 by writing to register or region of memory to indicate completion of the request.

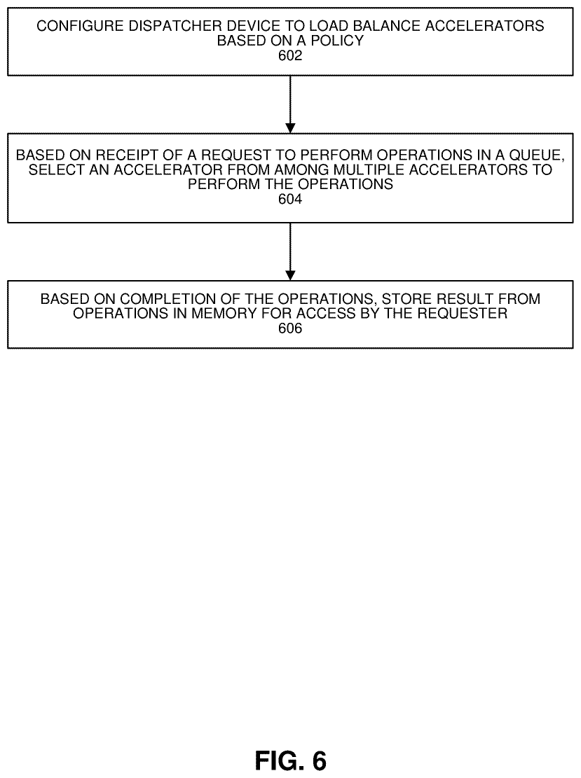

FIG. 6 depicts an example process. The process can be performed by a dispatcher device in some examples. At 602, the dispatcher device can be configured with a policy to apply to load balance requests or jobs, submitted to a single queue, among multiple accelerators. The policy can specify a manner of selecting a queue of an accelerator of the multiple accelerators for allocation of the request based on load data and/or priority of the requester or the request. In some cases, a request can include multiple operations and the dispatcher device can allocate the operations among multiple operations to be performed by accelerators in parallel. At 604, the dispatcher device can access requests to perform operations from a single queue. The dispatcher device can allocate the requests from the single queue for performance among multiple accelerators based on load data and/or priority of the requester or the request in accordance with the applicable policy. At 606, based on completion of the operations specified in a request by an accelerator, the accelerator can store data generated by the operations to a memory region specified by the request and indicate to the requester process that the request is completed. The request process can access the processed data.

FIG. 7 depicts a system. The system can use examples to perform processes that issue requests to a single queue to be performed by one or multiple accelerator devices, where the accelerator is selected by the dispatcher device, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die.

Accelerators 742 can be a fixed function or programmable offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as static random-access memory (SRAM), dynamic random-access memory (DRAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 732 or driver can advertise capability of a dispatcher device of accelerators 742 to a single queue in memory 730 to be performed by one or multiple accelerator devices, where the accelerator is selected by the dispatcher device, as described herein. In some examples, OS 732 or driver can enable or disable dispatcher to of accelerators 742 to a single queue in memory 730 to be performed by one or multiple accelerator devices, where the accelerator is selected by the dispatcher device, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. In some examples, network interface 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 750 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel® QuickPath Interconnect (QPI), Intel® Ultra Path Interconnect (UPI), Intel® On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Various examples include a computer-implemented method comprising: accessing requests to perform operations from a single queue associated with a device and the device allocating the requests for performance among multiple accelerators based on load data and priority of requests.

In some examples, the load data comprises one or more of: a queue length of an accelerator of the multiple accelerators, a number of operations to be performed by the accelerator of the multiple accelerators, or an average amount of time to completion by the accelerator of the multiple accelerators.

In some examples, the requests comprise a call to an application programming interface (API) that specifies one or more of: a starting memory address of data to be processed, operation to perform, or a starting memory address of a result of the operation.

In some examples, the requests comprise a write to a memory-mapped I/O (MMIO) region associated with the device or execution of an ENQCMD instruction.

In some examples, the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.

Example 1 includes one or more examples and includes an apparatus that includes: an interface and circuitry, coupled to the interface, to access a request to perform operations written to a single queue, wherein the circuitry is to allocate the operations from the single queue to multiple queues associated with multiple accelerators based on load data of the multiple accelerators and wherein at least one of the multiple accelerators is associated with at least two queues.

Example 2 includes one or more examples, wherein the load data comprises one or more of: a queue length of an accelerator of the multiple accelerators, a number of operations to be performed by the accelerator of the multiple accelerators, or an average amount of time to completion by the accelerator of the multiple accelerators.

Example 3 includes one or more examples, wherein the circuitry is to allocate the operations for performance by the multiple accelerators based on load data of the multiple accelerators and priority of the request.

Example 4 includes one or more examples, wherein the multiple accelerators are configured to perform the operations.

Example 5 includes one or more examples, wherein the request comprises a call to an application programming interface (API) that specifies one or more of: a starting memory address of data to be processed, the operations to perform, or a starting memory address of a result of the operations.

Example 6 includes one or more examples, wherein the request comprises a write to a memory-mapped I/O (MMIO) region associated with the circuitry.

Example 7 includes one or more examples, wherein the request comprises execution of an ENQCMD instruction to write the request to a register accessible by the circuitry.

Example 8 includes one or more examples, wherein the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.

Example 9 includes one or more examples, wherein the circuitry is accessible as a Peripheral Component Interconnect express (PCIe) device.

Example 10 includes one or more examples, and includes at least one non-transitory computer-readable medium comprising instructions stored thereon, that if executed by one or more processors, cause the one or more processors to: execute a driver to provide an interface to a single queue of a device, wherein the single queue receives requests to multiple accelerators to perform offloaded operations and the device is to load balance the offloaded operations among the multiple accelerators to perform the operations based on load data of the multiple accelerators and priority levels of the requests and wherein at least one of the multiple accelerators is associated with at least two queues.

Example 11 includes one or more examples, wherein the load data comprises one or more of: a queue length of an accelerator of the multiple accelerators, a number of operations to be performed by the accelerator of the multiple accelerators, or an average amount of time to completion by the accelerator of the multiple accelerators.

Example 12 includes one or more examples, wherein the requests comprise a call to an application programming interface (API) that specifies one or more of: a starting memory address of data to be processed, the operations to perform, or a starting memory address of a result of the operations.

Example 13 includes one or more examples, wherein the requests comprise a write to a memory-mapped I/O (MMIO) region associated with the device.

Example 14 includes one or more examples, wherein the requests comprise execution of an ENQCMD instruction to write the request to a register accessible by the device.

Example 15 includes one or more examples, wherein the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.

Example 16 includes one or more examples, wherein the device is accessible as a Peripheral Component Interconnect express (PCIe) device.

Example 17 includes one or more examples, and includes a system that includes: a processor; a memory; multiple accelerators; and circuitry, coupled to the memory, the circuitry to: access a request to perform operations written to a single queue allocated in the memory, wherein the circuitry is to allocate the operations to multiple queues associated with the multiple accelerators based on load data of the multiple accelerators and wherein at least one of the multiple accelerators is associated with at least two queues.

Example 18 includes one or more examples, wherein the load data comprises one or more of: a queue length of an accelerator of the multiple accelerators, a number of operations to be performed by the accelerator of the multiple accelerators, or an average amount of time to completion by the accelerator of the multiple accelerators.

Example 19 includes one or more examples, wherein the request comprises a write to a memory-mapped I/O (MMIO) region associated with the circuitry or execution of an ENQCMD instruction to write the request to a register accessible by the circuitry.

Example 20 includes one or more examples, wherein the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.

1. An apparatus comprising:
an interface and
circuitry, coupled to the interface, to access a request to perform operations written to a single queue, wherein the circuitry is to allocate the operations from the single queue to multiple queues associated with multiple accelerators based on load data of the multiple accelerators and wherein at least one of the multiple accelerators is associated with at least two queues.

2. The apparatus of claim 1, wherein the load data comprises one or more of: a queue length of an accelerator of the multiple accelerators, a number of operations to be performed by the accelerator of the multiple accelerators, or an average amount of time to completion by the accelerator of the multiple accelerators.

3. The apparatus of claim 1, wherein the circuitry is to allocate the operations for performance by the multiple accelerators based on load data of the multiple accelerators and priority of the request.

4. The apparatus of claim 1, wherein the multiple accelerators are configured to perform the operations.

5. The apparatus of claim 1, wherein the request comprises a call to an application programming interface (API) that specifies one or more of: a starting memory address of data to be processed, the operations to perform, or a starting memory address of a result of the operations.

6. The apparatus of claim 1, wherein the request comprises a write to a memory-mapped I/O (MMIO) region associated with the circuitry.

7. The apparatus of claim 1, wherein the request comprises execution of an ENQCMD instruction to write the request to a register accessible by the circuitry.

8. The apparatus of claim 1, wherein the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.

9. The apparatus of claim 1, wherein the circuitry is accessible as a Peripheral Component Interconnect express (PCIe) device.

10. At least one non-transitory computer-readable medium comprising instructions stored thereon, that if executed by one or more processors, cause the one or more processors to:
execute a driver to provide an interface to a single queue of a device, wherein the single queue receives requests to multiple accelerators to perform offloaded operations and the device is to load balance the offloaded operations among the multiple accelerators to perform the operations based on load data of the multiple accelerators and priority levels of the requests and wherein at least one of the multiple accelerators is associated with at least two queues.

11. The non-transitory computer-readable medium of claim 10, wherein the load data comprises one or more of: a queue length of an accelerator of the multiple accelerators, a number of operations to be performed by the accelerator of the multiple accelerators, or an average amount of time to completion by the accelerator of the multiple accelerators.

12. The non-transitory computer-readable medium of claim 10, wherein the requests comprise a call to an application programming interface (API) that specifies one or more of: a starting memory address of data to be processed, the operations to perform, or a starting memory address of a result of the operations.

13. The non-transitory computer-readable medium of claim 10, wherein the requests comprise a write to a memory-mapped I/O (MMIO) region associated with the device.

14. The non-transitory computer-readable medium of claim 10, wherein the requests comprise execution of an ENQCMD instruction to write the request to a register accessible by the device.

15. The non-transitory computer-readable medium of claim 10, wherein the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.

16. The non-transitory computer-readable medium of claim 10, wherein the device is accessible as a Peripheral Component Interconnect express (PCIe) device.

17. A system comprising:
a processor;
a memory;
multiple accelerators; and
circuitry, coupled to the memory, the circuitry to:
access a request to perform operations written to a single queue allocated in the memory, wherein the circuitry is to allocate the operations to multiple queues associated with the multiple accelerators based on load data of the multiple accelerators and wherein at least one of the multiple accelerators is associated with at least two queues.

18. The system of claim 17, wherein the load data comprises one or more of: a queue length of an accelerator of the multiple accelerators, a number of operations to be performed by the accelerator of the multiple accelerators, or an average amount of time to completion by the accelerator of the multiple accelerators.

19. The system of claim 17, wherein the request comprises a write to a memory-mapped I/O (MMIO) region associated with the circuitry or execution of an ENQCMD instruction to write the request to a register accessible by the circuitry.

20. The system of claim 17, wherein the multiple accelerators are to perform operations comprising one or more of: encryption, decryption, compression, decompression, packet transmission, packet receipt, data copying, cyclic redundancy check (CRC) calculations, matrix multiplication, convolution, tensor operations, arithmetic, or inference.
